(19) United States
(12) Patent Application Publication
(10) Pub. No.: US 2022/0004842 A1
(43) Pub. Date: Jan. 6, 2022

(54) Distributed Processing System and Distributed Processing Method

(71) Applicant: Nippon Telegraph and Telephone Corporation, Tokyo (JP)

(72) Inventors: Kenji Kawai, Tokyo (JP); Junichi Kato, Tokyo (JP); Huycu Ngo, Tokyo (JP); Yuki Arikawa, Tokyo (JP); Tsuyoshi Ito, Tokyo (JP); Takeshi Sakamoto, Tokyo (JP)

(21) Appl. No.: 17/287,413

(22) PCT Filed: Oct. 7, 2019
(86) PCT No.: PCT/JP2019/039449

§ 371 Date: Apr. 21, 2021

(30) Foreign Application Priority Data
Oct. 22, 2018 (JP) 2018-198230

(51) Int. Cl. G06N 3/04; G06N 3/08; G06N 3/063

(52) U.S. Cl. CPC G06N 3/04; G06N 3/063; G06N 3/08

(57) ABSTRACT

A first distributed processing node transmits distributed data as intermediate consolidated data from a first communication port to a second distributed processing node. A third distributed processing node generates updated intermediate consolidated data from the received intermediate consolidated data and distributed data, and transmits the data from the first communication port to a fourth distributed processing node. The first distributed processing node transmits intermediate consolidated data received via a second communication port as consolidated data to a fifth distributed processing node from the second communication port. The third distributed processing node transmits consolidated data received via the first communication port to a sixth distributed processing node from the second communication port. Each of the distributed processing nodes updates a weight of a neural network based on the consolidated data.

This patent application is a national phase filing under section 371 of PCT/JP2019/039449, filed Oct. 7, 2019, which claims the priority of Japanese patent application no. 2018-198230, filed Oct. 22, 2018, each of which is incorporated herein by reference in its entirety.

### TECHNICAL FIELD

The present disclosure relates to a distributed processing system including a plurality of distributed processing nodes, and particularly relates to a distributed processing system and a distributed processing method for consolidating numerical data from each of the distributed processing nodes to generate consolidated data, and distributing the consolidated data to each of the distributed processing nodes.

### BACKGROUND

In deep learning, the accuracy of inference is improved by updating a weight of each neuron model (a coefficient multiplied by a value output by a neuron model at a previous stage) on the basis of input sample data for a learning target constituted by a multi-layered neuron model.

A mini batch method is typically used for a method of improving the accuracy of inference. In a mini batch method, a gradient calculation process of calculating a gradient with respect to the weight for each piece of sample data, a consolidation process of consolidating the gradient for a plurality of different pieces of sample data (summing up the gradients, obtained for each piece of sample data, for each weight), and a weight updating process of updating each weight on the basis of the consolidated gradient are repeated.

These processes, particularly the gradient calculation process, require many iterated computations, but there is a problem in that a time required for deep learning increases as the number of weights and the number of pieces of input sample data increase in order to improve the accuracy of inference.

In order to increase the speed of the gradient calculation process, a distributed processing method is used. Specifically, a plurality of distributed processing nodes are provided, and each of the nodes performs a gradient calculation process for each of different pieces of sample data. As a result, as the number of pieces of sample data that can be processed per unit time can be increased in proportion to the number of nodes, the speed of the gradient calculation process can be increased (see NPL 1).

In a consolidation process in distributed processing for deep learning, it is required that communication (aggregation communication) for transferring data (distributed data) calculated at each of the distributed processing nodes to a node which performs a consolidation process, a consolidation process (inter-node consolidation process) based on data acquired through the aggregation communication, and communication (dispatch communication) for distributing, to each of the distributed processing nodes, the data (consolidated data) obtained by consolidating the data acquired from the distributed processing nodes, are performed between a gradient calculation process of calculating a gradient with respect to the weight for each piece of sample data as well as an in-node consolidation process of summing up the gradients, obtained for each piece of sample data, for each weight, and a weight updating process of updating each weight on the basis of the consolidated gradient, by each of the distributed processing nodes.

Requiring times for the above-described aggregation communication and dispatch communication, which are not required in a system that performs deep learning in a single node, results in a reduction in a processing speed in performing distributed processing of deep learning.

In recent years, deep learning has been applied to more complicated problems, and a total number of weights tends to increase. Thus, the amount of distributed data and the amount of the consolidated data have increased, and an aggregation communication time and a dispatch communication time have increased.

As described above, a distributed processing system for deep learning has a problem that, because of an increase in the number of distributed processing nodes, the effect of increasing the speed of deep learning is reduced due to increases in the aggregation communication time and the dispatch communication time.

FIG. 12 illustrates a relationship between the number of distributed processing nodes and processing performance of deep learning in the distributed processing system of the related art, a reference numeral 200 denotes an ideal relationship between the number of distributed processing nodes and processing performance (performance ∝ the number of nodes), and a reference numeral 201 denotes an actual relationship between the number of distributed processing nodes and processing performance. The total amount of distributed data, which is an input of the inter-node consolidation process, is increased in proportion to the number of distributed processing nodes, but the actual processing performance does not improve in proportion to the number of distributed processing nodes. This is because the communication speed of the consolidation processing node is limited to equal to or less than the physical speed of the communication port of the node, and thus the time required for the aggregation communication increases.

### CITATION LIST

### Non Patent Literature

NPL 1: Akiba Takuya, “Distributed Deep Learning Package ChainerMN Release,” Preferred Infrastructure, 2017, Internet https://research.preferred.jp/2017/05/chainermn-beta-release/.

### SUMMARY

### Technical Problem

Embodiments of the present disclosure take into consideration the above-described situations, and embodiments provide a distributed processing system and a distributed processing method which can perform an effective distributed process when being applied to deep learning in a distributed processing system that includes a plurality of distributed processing nodes.

### Means for Solving the Problem

A distributed processing system according to embodiments of the present disclosure includes N (N is an integer greater than or equal to 2) distributed processing nodes arranged in a ring shape and each of the N distributed processing nodes is connected with adjacent nodes through a communication path. An n^{th} (n=1, . . . , N) distributed processing node includes a first communication port configured to simultaneously communicate in both directions with an n^{+th} (n⁺=n+1, provided that n⁺=1 if n=N) distributed processing node and a second communication port configured to simultaneously communicate in both directions with an n^{-th} (n⁻=n−1, provided that n⁻=N if n=1) distributed processing node. Each of the distributed processing nodes generates distributed data for M (M is an integer greater than or equal to 2) weights w[m] (m=1, . . . , M) of a neural network that is a learning target. A predetermined first distributed processing node that is one of the N distributed processing nodes defines distributed data generated at the first distributed processing node as first consolidated data, packetizes the first consolidated data in order of a number m of the weight w[m], and transmits the packet from the first communication port of the first distributed processing node to a second distributed processing node. A k^{th} (k=2, . . . , N) distributed processing node that is one of the N distributed processing nodes and is not the first distributed processing node calculates, for each corresponding weight w[m], a sum of first consolidated data received from a (k−1)^{th} distributed processing node via the second communication port of the k^{th} distributed processing node and distributed data generated at the k^{th} distributed processing node to generate updated first consolidated data, packetizes the first consolidated data in order of the number m, and transmits the packet from the first communication port of the k^{th} distributed processing node to a k^{+th} (k⁺=k+1, provided that k⁺=1 if k=N) distributed processing node. The first distributed processing node defines first consolidated data received from the N^{th} distributed processing node via the second communication port of the first distributed processing node as second consolidated data, packetizes the second consolidated data in order of the number m, and transmits the packet from the second communication port of the first distributed processing node to the N^{th} distributed processing node. The k^{th} distributed processing node packetizes, in order of the number m, second consolidated data received from the k^{+th} distributed processing node via the first communication port of the k^{th} distributed processing node, and transmits the packet from the second communication port of the k^{th} distributed processing node to the (k−1)^{th} distributed processing node. The first distributed processing node receives second consolidated data from the second distributed processing node via the first communication port of the first distributed processing node. Each of the distributed processing nodes updates the weight w[m] of the neural network based on the received second consolidated data.

In one configuration example of the distributed processing system according to embodiments of the present disclosure, each of the distributed processing nodes includes an in-node consolidation processing unit configured to generate the distributed data, a first transmission unit configured to, when the distributed processing node functions as the first distributed processing node, packetize the first consolidated data in order of the number m of the weight w[m] and transmit the packet from the first communication port of the distributed processing node to the second distributed processing node, and when the distributed processing node functions as the k^{th} distributed processing node, packetize the updated first consolidated data in order of the number m and transmit the packet from the first communication port of the distributed processing node to the k^{+th} distributed processing node, a first reception unit configured to acquire the first consolidated data from a packet received from the second communication port of the distributed processing node, a second transmission unit configured to, when the distributed processing node functions as the first distributed processing node, packetize the second consolidated data in order of the number m and transmit the packet from the second communication port of the distributed processing node to the N^{th} distributed processing node, and when the distributed processing node functions as the k^{th} distributed processing node, packetize the received second consolidated data in order of the number m and transmit the packet from the second communication port of the distributed processing node to the (k−1)^{th} distributed processing node, a second reception unit configured to acquire the second consolidated data from a packet received from the first communication port of the distributed processing node, a consolidated data generation unit configured to, when the distributed processing node functions as the k^{th} distributed processing node, generate the updated first consolidated data, and a weight updating processing unit configured to update the weight w[m] of the neural network based on the received second consolidated data.

In one configuration example of the distributed processing system according to embodiments of the present disclosure, each of the distributed processing nodes performs the transmission of the first consolidated data and the subsequent processes again when the first distributed processing node fails to successfully receive the second consolidated data.

Embodiments of the present disclosure also provide a distributed processing method in a system, the system including N (N is an integer greater than or equal to 2) distributed processing nodes arranged in a ring shape, each of the N distributed processing nodes being connected with adjacent nodes through a communication path. In the system, an n^{th} (n=1, . . . , N) distributed processing node includes a first communication port configured to simultaneously communicate in both directions with an n^{+th} (n⁺=n+1, provided that n⁺=1 if n=N) distributed processing node and a second communication port configured to simultaneously communicate in both directions with an n^{-th} (n⁻=n−1, provided that n⁻=N if n=1) distributed processing node. The method includes a first step of generating, at each of the distributed processing nodes, distributed data for M (M is an integer greater than or equal to 2) weights w[m] (m=1, . . . , M) of a neural network that is a learning target, a second step of defining, at a predetermined first distributed processing node that is one of the N distributed processing nodes, distributed data generated at the first distributed processing node as first consolidated data, packetizing the first consolidated data in order of a number m of the weight w[m], and transmitting the packet from the first communication port of the first distributed processing node to a second distributed processing node, a third step of calculating, for each corresponding weight w[m], at a k^{th} (k=2, . . . , N) distributed processing node that is one of the N distributed processing nodes and is not the first distributed processing node, a sum of first consolidated data received from a (k−1)^{th} distributed processing node via the second communication port of the k^{th} distributed processing node and distributed data generated at the k^{th} distributed processing node to generate updated first consolidated data, packetizing the first consolidated data in order of the number m, and transmitting the packet from the first communication port of the k^{th} distributed processing node to a k^{+th} (k⁺=k+1, provided that k⁺=1 if k=N) distributed processing node, a fourth step of defining, by the first distributed processing node, first consolidated data received from the N^{th} distributed processing node via the second communication port of the first distributed processing node as second consolidated data, packetizing the second consolidated data in order of the number m, and transmitting the packet from the second communication port of the first distributed processing node to the N^{th} distributed processing node, a fifth step of packetizing, in order of the number m, at the k^{th} distributed processing node, second consolidated data received from the k^{+th} distributed processing node via the first communication port of the k^{th} distributed processing node, and transmitting the packet from the second communication port of the k^{th} distributed processing node to the (k−1)^{th} distributed processing node, a sixth step of receiving, at the first distributed processing node, second consolidated data from the second distributed processing node via the first communication port of the first distributed processing node, and a seventh step of updating, at each of the distributed processing nodes, the weight w[m] of the neural network based on the received second consolidated data.

In one configuration example of the distributed processing method according to embodiments of the present disclosure, the third step includes, at the k^{th} distributed processing node, acquiring the first consolidated data from a packet received from the second communication port of the k^{th} distributed processing node, generating the updated first consolidated data, and packetizing the updated first consolidated data in order of the number m and transmitting the packet from the first communication port of the k^{th} distributed processing node to the k^{+th} distributed processing node. The fourth step includes, at the first distributed processing node, acquiring the first consolidated data from a packet received from the second communication port of the first distributed processing node, and defining the acquired first consolidated data as second consolidated data, packetizing the second consolidated data in order of the number m, and transmitting the packet from the second communication port of the first distributed processing node to the N^{th} distributed processing node. The fifth step includes, at the k^{th} distributed processing node, acquiring the second consolidated data from a packet received from the first communication port of the k^{th} distributed processing node, packetizing the received second consolidated data in order of the number m, and transmitting the packet from the second communication port of the k^{th} distributed processing node to the (k−1)^{th} distributed processing node, and the sixth step includes, at the first distributed processing node, acquiring the second consolidated data from a packet received from the first communication port of the first distributed processing node.

One configuration example of the distributed processing method according to embodiments of the present disclosure includes, at each of the distributed processing nodes, performing processes of the second and the subsequent steps again when the first distributed processing node fails to successfully receive the second consolidated data in the sixth step.

### Effects of Embodiments of the Invention

According to embodiments of the present disclosure, aggregation communication from an n^{th} (n=1, . . . , N) distributed processing node to an n^{+th} (n⁺=n+1, provided that n⁺=1 if n=N) distributed processing node (a process of transmitting first consolidated data to the n^{+th} distributed processing node), an inter-node consolidation process performed by a k^{th} (k=2, . . . , N) distributed processing node (a process of calculating updated first consolidated data based on received first consolidated data and distributed data generated at the k^{th} distributed processing node), and dispatch communication from the n^{th} distributed processing node to an n^{-th} (n⁻=n−1, provided that n⁻=N if n=1) distributed processing node (a process of distributing second consolidated data to the n^{th} distributed processing node) can be performed concurrently and substantially simultaneously. This allows effective distributed processing, and thus, learning efficiency of the neural network can be improved. According to embodiments of the present disclosure, a first communication port and a second communication port are provided to each of the distributed processing nodes, and directions of the aggregation communication and the dispatch communication are opposite to each other, and thus, it is not necessary to postpone a start of the dispatch communication until the aggregation communication is completed. According to embodiments of the present disclosure, distributed processing of deep learning can be performed without providing consolidation processing nodes, and the speed of the distributed processing is not limited by the communication speed of the consolidation processing node. According to embodiments of the present disclosure, even in a case where the N distributed processing nodes are nodes including the same hardware, the aggregation communication process, the inter-node consolidation process, and the dispatch communication process can be performed by selecting a node as a parent node (first distributed processing node) and then applying a setting depending on whether the node is the parent node or not to each of the distributed processing nodes. Thus, the system can be extremely easily managed compared to a system requiring a separate setting for each of the distributed processing nodes, and thus, the costs required for system management and administrative errors can be reduced.

According to embodiments of the present disclosure, each of the distributed processing nodes performs the transmission of the first consolidated data and the subsequent processes again when the first distributed processing node fails to successfully receive the second consolidated data. According to embodiments of the present disclosure, normal processes in all of the distributed processing nodes are ensured when the second consolidated data sent out from the first distributed processing node returns back, and thus, state monitoring of each of the distributed processing nodes is unnecessary, and the integrity of data can be ensured in a simple manner and with low latency by using only the first distributed processing node.

### BRIEF DESCRIPTION OF THE DRAWINGS

FIG. 1 is a block diagram illustrating a configuration example of a distributed processing system for deep learning according to a first embodiment of the present disclosure.

FIG. 2 is a flowchart illustrating a sample data input process, a gradient calculation process, and an in-node consolidation process of a distributed processing node according to the first embodiment of the present disclosure.

FIG. 3 is a flowchart illustrating an aggregation communication process, an inter-node consolidation process, and a dispatch communication process of the distributed processing node according to the first embodiment of the present disclosure.

FIG. 4 is a flowchart illustrating a weight updating process of the distributed processing node according to the first embodiment of the present disclosure.

FIG. 5 is a block diagram illustrating a configuration example of a distributed processing node according to a second embodiment of the present disclosure.

FIG. 6 is a block diagram illustrating a configuration example of the distributed processing node according to the second embodiment of the present disclosure.

FIG. 7 is a diagram illustrating an overview of a process of the distributed processing node according to the second embodiment of the present disclosure.

FIG. 8 is a diagram illustrating a sequence of communication of intermediate consolidated data and consolidated data between the distributed processing nodes according to the second embodiment of the present disclosure.

FIG. 9 is a diagram illustrating a sequence of communication of the intermediate consolidated data and the consolidated data between the distributed processing nodes according to the second embodiment of the present disclosure.

FIG. 10 is a diagram illustrating a sequence of communication of the intermediate consolidated data and the consolidated data between the distributed processing nodes according to the second embodiment of the present disclosure.

FIG. 11 is a block diagram illustrating a configuration example of a computer that realizes the distributed processing node according to the first and second embodiments of the present disclosure.

FIG. 12 is a diagram illustrating a relationship between the number of distributed processing nodes and processing performance of deep learning in a distributed processing system of the related art.

### DETAILED DESCRIPTION OF ILLUSTRATIVE EMBODIMENTS

### First Embodiment

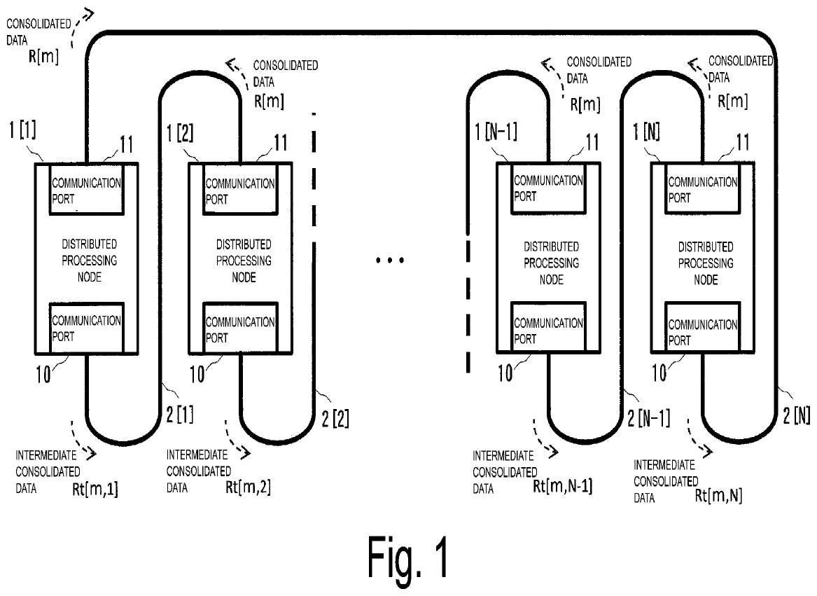

Embodiments of the present disclosure will be described below with reference to the drawings. FIG. 1 is a block diagram illustrating a configuration example of a distributed processing system for deep learning according to a first embodiment of the present disclosure. The distributed processing system in FIG. 1 includes N (N is an integer greater than or equal to 2) distributed processing nodes 1[n] (n=1, . . . , N), and a communication path 2[n] (n=1, . . . , N) through which a distributed processing node 1[n] (n=1, . . . , N) of a number n and a distributed processing node 1[n⁺] of the following number n⁺(n⁺=n+1, provided that n⁺=1 if n=N) communicate with each other in both directions. Note that, in addition to a transmission line, a relay processing node that relays communication can be optionally interposed in any communication path 2[n] (n=1, . . . , N).

Each of the distributed processing nodes 1[n] (n=1, . . . , N) includes a communication port 10 and a communication port 11 that can simultaneously communicate in both directions. The communication port 10 is a communication port through which the distributed processing node 1[n] communicates in both directions with the distributed processing node 1[n⁺] (n⁺=n+1, provided that n⁺=1 if n=N), and is connected to a communication path 2[n]. The communication port 11 is a communication port through which the distributed processing node 1[n] communicates in both directions with the distributed processing node 1[n⁻] (n⁻=n−1, provided that n⁻=N if n=1), and is connected to a communication path 2[n⁻].

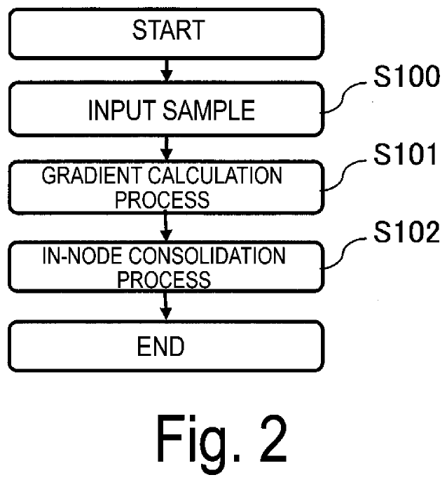

FIG. 2 is a flowchart illustrating a sample data input process, a gradient calculation process, and an in-node consolidation process of the distributed processing node 1[n]. Each of the distributed processing nodes 1[n] (n=N) inputs different S (S is an integer greater than or equal to 2) pieces of sample data x[n, s] (s=1, . . . , S) or each mini batch from a data collecting node which is not shown in the drawing (step S100 in FIG. 2).

Note that the present invention is not limited to a sample data collecting method performed by a data collecting node and a method of dividing collected sample data into N sets and distributing each of the sets to each of the distributed processing nodes 1[n], and any method can be applied.

When sample data x[n, s] is input, each of the distributed processing nodes 1[n] (n=1, . . . , N) calculates a gradient G[m, n, s] of a loss function of a neural network for each piece of sample data x[n, s] with respect to each of M (M is an integer greater than or equal to 2) weights w[m] (m=. . . , M) of the neural network that is a learning target (step S101 in FIG. 2).

A method of constructing the neural network in each of the distributed processing nodes 1[n] as software, a weight w[m] of the neural network, a loss function, which is an indicator indicating the degree of poorness of performance of the neural network, and a gradient G[m, n, s] of the loss function are well-known techniques, and thus detailed description thereof will be omitted.

Next, each of the distributed processing nodes 1[n] (n=1, . . . , N) generates and stores distributed data D[m, n] (m=1, . . . , M), which is numerical values obtained by consolidating a gradient G[m, n, s] for each piece of sample data, for each weight w[m] (step S102 in FIG. 2). A calculation equation for the distributed data D[m, n] is as follows.

D[m, n]=Σ_{s=1, . . . , S}G[m, n, s] (1)

Note that the gradient calculation process in step S101 and the in-node consolidation process in step S102 can be performed in a pipelined manner in units of sample data (the gradient calculation process for any sample data and the in-node consolidation process of consolidating a gradient obtained from one sample data prior to the sample data can be performed at the same time).

Furthermore, each of the distributed processing nodes 1[n] (n=1, . . . , N) generates the distributed data D[m, n] (m=1, . . . , M), and then performs aggregation communication between the distributed processing nodes, and performs an inter-node consolidation process for generating consolidated data.

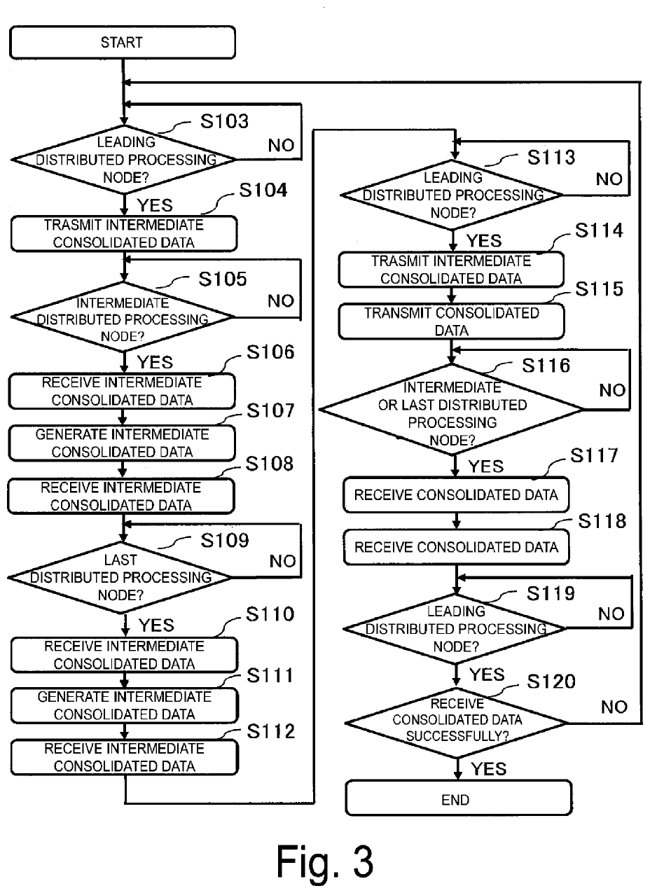

FIG. 3 is a flowchart illustrating an aggregation communication process, an inter-node consolidation process, and a dispatch communication process of the distributed processing node 1[n].

First, a first distributed processing node 1[1] transmits M pieces of distributed data D[m, 1] (m=1, . . . , M) generated at the distributed processing node 1[1], as intermediate consolidated data Rt[m, 1], to a distributed processing node 1[2] of the following number via the communication port 10 of the distributed processing node 1[1] and a communication path 2[1] (steps S103 and S104 in FIG. 3). That is, the intermediate consolidated data Rt[m, 1] at this time is the same as the distributed data D[m, 1].

Rt[m, 1]=D[m, 1] (2)

Here, the first distributed processing node 1[1] is a predetermined first distributed processing node that is one of the plurality of distributed processing nodes 1[n] (n=1, . . . , N).

Next, an intermediate distributed processing node 1[1] (i=2, . . . , N−1) receives intermediate consolidated data Rt[m, i−1] (m=1, . . . , M) from a distributed processing node 1[1−1] via the communication port 11 of the distributed processing node 1[1] and a communication path 2[i−1] (steps S105 and S106 in FIG. 3). Here, the intermediate distributed processing node 1[1] is a predetermined intermediate distributed processing node that is one of the plurality of distributed processing nodes 1[n] (n=1, . . . , N) and is not the first and N^{th} distributed processing nodes.

The intermediate distributed processing node 1[1] (i=2, . . . , N−1) calculates, for each corresponding weight w[m], the sum of the received intermediate consolidated data Rt[m, i−1] (m=1, . . . , M) and distributed data D[m, i] generated at the distributed processing node 1[1] to generate intermediate consolidated data Rt[m, i] (step S107 in FIG. 3). That is, the intermediate consolidated data Rt[m, i] is constituted by M numerical values. A calculation equation for the intermediate consolidated data Rt[m, i] is as follows.

Rt[m, i]=Rt[m, i−1]+D[m, i] (3)

Then, the intermediate distributed processing node 1[1] (i=2, . . . , N−1) transmits the intermediate consolidated data Rt[m, i] (m=1, . . . , M) generated at the distributed processing node 1[1] to a distributed processing node 1[1+1] of the following number via the communication port 10 of the distributed processing node 1[1] and a communication path 2[i] (step S108 in FIG. 3).

A predetermined N^{th} distributed processing node 1[N] that is one of the plurality of distributed processing nodes 1[n] (n=1, . . . , N) receives intermediate consolidated data Rt[m, N−1] from a distributed processing node 1[N−1] via the communication port 11 of the distributed processing node 1[N] and a communication path 2[N−1] (steps S109 and S110 in FIG. 3).

The N^{th} distributed processing node 1[N] calculates, for each corresponding weight w[m], the sum of the received intermediate consolidated data Rt[m, N−1] (m=1, . . . , M) and distributed data D[m, N] generated at the distributed processing node 1[N] to generate intermediate consolidated data Rt[m, N] (step S111 in FIG. 3). That is, the intermediate consolidated data Rt[m, N] is constituted by M numerical values. A calculation equation for the intermediate consolidated data Rt[m, N] is as follows.

Rt[m, N]=Rt[m, N−1]+D[m, N] (4)

Then, the N^{th} distributed processing node 1[N] transmits the intermediate consolidated data Rt[m, N] (m=1, . . . , M) generated at the distributed processing node 1[N] to the first distributed processing node 1[1] via the communication port 10 of the distributed processing node 1[N] and a communication path 2[N] (step S112 in FIG. 3).

In this manner, the intermediate consolidated data Rt[m, N] constituted by M numerical values, which is calculated using the equations (2), (3), and (4), is calculated based on the distributed data D[m, n] (m=1, . . . , M) constituted by M numerical values generated at each of the distributed processing nodes 1[n] (n=1, . . . , N). A value of the intermediate consolidated data Rt[m, N] can be expressed by the following equation.

Rt[m, N]=Σ_{n=1, . . . , N}D[m,n] (5)

Next, dispatch communication is performed in which the intermediate consolidated data Rt[m, N] (m=1, . . . , M) is distributed as consolidated data to each of the distributed processing nodes 1[n] (n=1, . . . , N).

The first distributed processing node 1[1] receives the intermediate consolidated data Rt[m, N] from the distributed processing node 1[N] via the communication port 11 of the distributed processing node 1[1] and the communication path 2[N] (steps S113 and S114 in FIG. 3).

The first distributed processing node 1[1] transmits the received intermediate consolidated data Rt[m, N] (m=1, . . . , M) as consolidated data R[m] to the N^{th} distributed processing node 1[N] via the communication port 11 of the distributed processing node 1[1] and the communication path 2[N] (step S115 in FIG. 3). In other words, the distributed processing node 1[1] returns the intermediate consolidated data Rt[m, N] from the distributed processing node 1[N], as the consolidated data R[m], to a distributed processing node [N]. The consolidated data R[m] is the same as the intermediate consolidated data Rt[m, N].

R[m]=Rt[m, N]=Σ_{n=1, . . . , N}D[m, n] (6)

Then, a distributed processing node 1[k] (k=N, . . . , 2) receives the consolidated data R[m] (m=1, . . . , M) from a distributed processing node 1[k⁺] (k⁺=k+1, provided that k⁺=1 if k=N) of the following number via the communication port 10 of the distributed processing node 1[k] and a communication path 2[k] (steps S116 and S117 in FIG. 3). Here, the distributed processing node 1[k] is a distributed processing node that is one of the plurality of distributed processing nodes 1[n] (n=1, . . . , N) and is not the first distributed processing node.

The distributed processing node 1[k] (k=N, . . . , 2), that is one of the distributed processing nodes 1[n] (n=1, . . . , N) and that is not the first distributed processing node, transmits the received consolidated data R[m] (m=1, . . . , M) to a distributed processing node 1[k−] of the previous number via the communication port 11 of the distributed processing node 1[k] and a communication path 2[k−1] (step S118 in FIG. 3).

The first distributed processing node 1[1] receives the consolidated data R[m] (m=1, . . . , M) from the distributed processing node 1[2] via the communication port 10 of the distributed processing node 1[1] and the communication path 2[1] (steps S119 and S120 in FIG. 3).

Here, in order for the first distributed processing node 1[1] to successfully receive the consolidated data R[m] constituted by M numerical values, another distributed processing node 1[k] (k=N, . . . , 2) needs to successfully receive the consolidated data R[m]. Each of the communication paths 2[n] (n=1, . . . , N) between the distributed processing nodes does not have a function of returning abnormal consolidated data R[m] to a normal state.

Thus, in a case where the distributed processing node 1[1] successfully receives the consolidated data R[m], it is guaranteed that all of the distributed processing nodes 1[n] (n=1, . . . , N) have successfully received the consolidated data R[m]. In a case where the distributed processing node 1[1] fails to successfully receive the consolidated data R[m] (NO in step S120), the process may return to step S103 to be restarted from the aggregation communication.

Note that whether or not the distributed processing node 1[1] has successfully received the consolidated data R[m] can be determined by comparing the consolidated data R[m] transmitted in step S115 with the consolidated data R[m] received in steps S119 and S120, for example. That is, if the transmitted consolidated data R[m] equals the received consolidated data R[m], it can be determined that the consolidated data R[m] has successfully been received.

With the above-described dispatch communication, all of the distributed processing nodes 1[n] (n=1, . . . , N) can acquire the same consolidated data R[m].

The aggregation communication is performed by using a route of the distributed processing node 1[1] -> the distributed processing node 1[2] ->. . . -> the distributed processing node 1[N] -> the distributed processing node 1[1]. The dispatch communication is performed by using a route of the distributed processing node 1[1] -> the distributed processing node 1[N] ->. . . -> the distributed processing node 1[2] -> the distributed processing node 1[1].

That is, the direction of the aggregation communication and the direction of the dispatch communication are opposite to each other. The aggregation communication and the dispatch communication are performed via the communication ports 10 and 11 and the communication path 2[n] that can simultaneously communicate in both directions, and thus, it is not necessary to postpone a start of the dispatch communication until the aggregation communication is completed.

That is, in a case where the distributed processing node 1[1] starts to receive the intermediate consolidated data Rt[m, N] before the distributed processing node 1[1] completes the transmission of the intermediate consolidated data Rt[m, i] (m=1, . . . , M), the dispatch communication using this intermediate consolidated data Rt[m, N] as the consolidated data R[m] can be started.

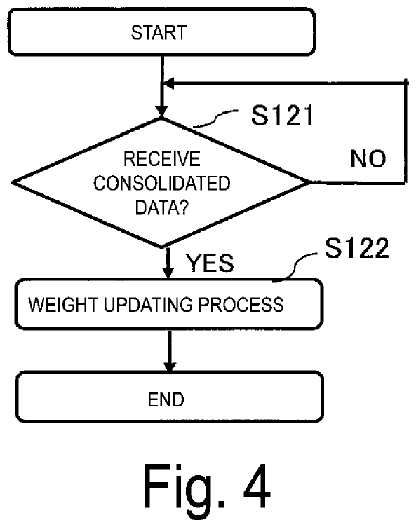

FIG. 4 is a flowchart illustrating a weight updating process of the distributed processing node 1[n] (n=1, . . . , N). Upon receiving the consolidated data R[m] (m=1, . . . , M) (YES in step S121 in FIG. 4), each of the distributed processing nodes 1[n] performs a weight updating process of updating weights w[m] of the neural networks in the distributed processing node 1[n], based on the received consolidated data R[m] (step S122 in FIG. 4). In the weight updating process, a weight w[m] may be updated for each number m so that a loss function is minimized on the basis of a gradient of the loss function which is indicated by consolidated data R[m]. The updating of a weight w[m] is a well-known technique, and thus detailed description thereof will be omitted.

As described above, the weight updating process is a process of updating the weight w[m] based on the pieces of consolidated data R[m] acquired in order of numbers m of weights w[m]. Thus, each of the distributed processing nodes 1[n] (n=1, . . . , N) can perform the weight updating process for the weight w[m] in order of the number m.

One mini batch learning is terminated due to the termination of the weight updating process, and each of the distributed processing nodes 1[n] (n=1, . . . , N) continuously performs the next mini batch learning process based on the updated weights w[m]. That is, each of the distributed processing nodes 1[n] receives sample data for the next mini batch learning from a data collecting node which is not shown in the drawing, and repeats the above-described mini batch learning process to improve the accuracy of inference of the neural network of the distributed processing node 1[n].

As illustrated in the present embodiment, it is not necessary to postpone a start of the dispatch communication until the aggregation communication is completed, and it is possible to start the dispatch communication from a portion of data that has been consolidated, even during the aggregation communication. Thus, it is possible to reduce the time from the start of the aggregation communication to the completion of the dispatch communication as compared with the known art in which the dispatch communication is started after the aggregation communication is completed. As a result, it is possible to provide a distributed system for deep learning with higher speed.

In addition, in the present embodiment, when the distributed processing node 1[1] has completed the acquisition of the consolidated data R[m], it is guaranteed that the other distributed processing nodes 1[k] (k=2, . . . , N) have completed the acquisition of the consolidated data R[m], and thus, it is possible to provide a distributed processing system for deep learning with high reliability.

### Second Embodiment

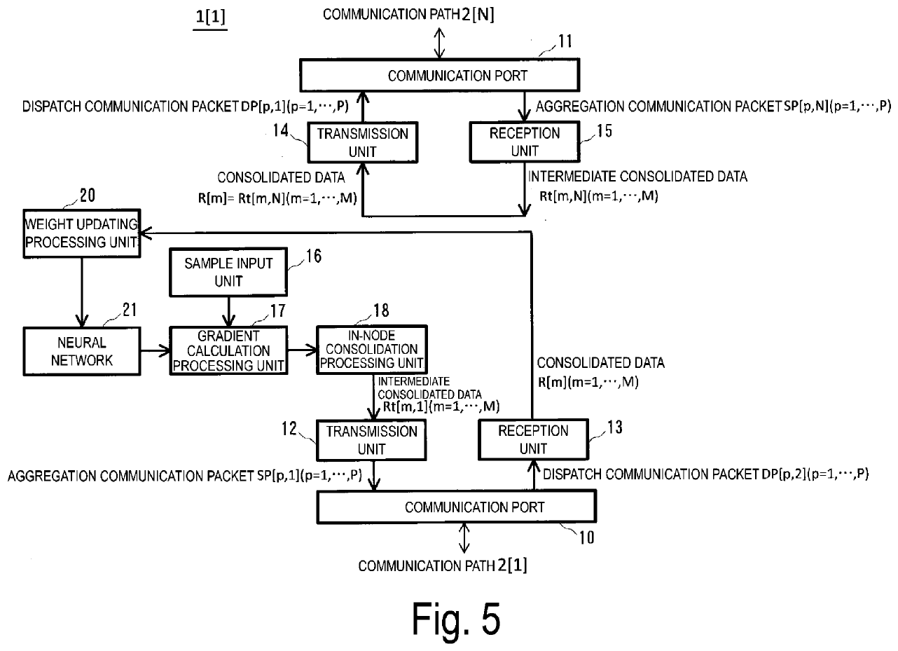

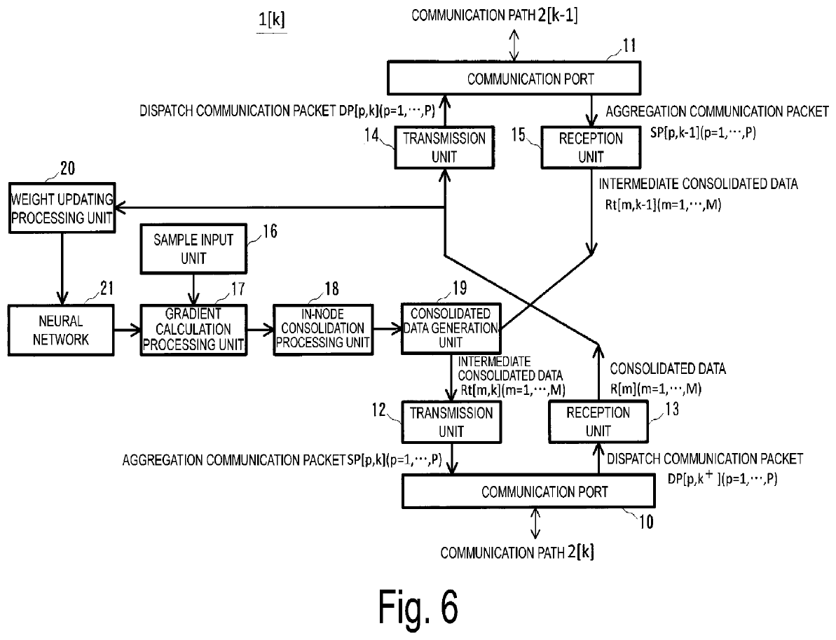

Next, a second embodiment of the present disclosure will be described. The present embodiment describes the first embodiment more specifically. FIG. 5 is a block diagram illustrating a configuration example of the distributed processing node 1[1] according to the present embodiment, and FIG. 6 is a block diagram illustrating a configuration example of the distributed processing node 1[k] (k=2, . . . , N) according to the present embodiment.

The distributed processing node 1[1] includes the communication port 10 (first communication port), the communication port 11 (second communication port), a transmission unit 12 (first transmission unit), a reception unit 13 (second reception unit), a transmission unit 14 (second transmission unit), a reception unit 15 (first reception unit), a sample input unit 16, a gradient calculation processing unit 17, an in-node consolidation processing unit 18, a weight updating processing unit 20, and a neural network 21. Here, the transmission unit 12 packetizes the intermediate consolidated data Rt[m, 1] (m=1, . . . , M) and outputs the packet to the communication port 10 of the distributed processing node 1[1]. The reception unit 13 acquires the consolidated data R[m] from the packet received from the communication port 10 of the distributed processing node 1[1]. The transmission unit 14 packetizes the consolidated data R[m] and outputs the packet to the communication port 11 of the distributed processing node 1[1]. The reception unit 15 acquires the intermediate consolidated data Rt[m, N] (m=1, . . . , M) from the packet received from the communication port 11 of the distributed processing node 1[1]. The sample input unit 16 receives sample data for learning from a data collecting node which is not shown in the drawing. When the sample data is input, the gradient calculation processing unit 17 calculates a gradient G[m, 1, s] of a loss function of the neural network for each piece of sample data with respect to each of the weights w[m] of the neural network. The in-node consolidation processing unit 18 generates and stores distributed data D[m, 1], which is numerical values obtained by consolidating a gradient G[m, n, s] for each piece of sample data, for each weight w[m]. The update processing unit 20 updates the weight of the neural network based on the consolidated data R[m]. The neural network 21 is a mathematical model built by software.

The distributed processing node 1[k] (k=2, . . . , N) includes the communication port 10 (first communication port), the communication port 11 (second communication port), the transmission unit 12 (first transmission unit), the reception unit 13 (second reception unit), the transmission unit 14 (second transmission unit), the reception unit 15 (first reception unit), the sample input unit 16, the gradient calculation processing unit 17, the in-node consolidation processing unit 18, a consolidated data generation unit 19, the weight updating processing unit 20, and the neural network 21. Here, the transmission unit 12 packetizes intermediate consolidated data Rt[m, k] (m=1, . . . , M) and outputs the packet to the communication port 10 of the distributed processing node 1[k]. The reception unit 13 acquires the consolidated data R[m] from the packet received from the communication port 10 of the distributed processing node 1[k]. The transmission unit 14 packetizes the consolidated data R[m] and outputs the packet to the communication port 11 of the distributed processing node 1[k]. The reception unit 15 acquires intermediate consolidated data Rt[m, k−1] (m=1, . . . , M) from the packet received from the communication port 11 of the distributed processing node 1[k]. When sample data is input, the gradient calculation processing unit 17 calculates a gradient G[m, k, s] of a loss function of the neural network for each piece of sample data with respect to each of the weights w[m] of the neural network. The in-node consolidation processing unit 18 generates and stores distributed data D[m, k], which is numerical values obtained by consolidating a gradient G[m, k, s] for each piece of sample data, for each weight w[m]. The consolidated data generation unit 19 calculates, for each corresponding weight w[m], the sum of the received intermediate consolidated data Rt[m, k−1] (m=1, . . . , M) and the distributed data D[m, k] generated at the distributed processing node 1[k] to generate updated intermediate consolidated data Rt[m, k].

Note that the distributed processing node 1[1] and the distributed processing node 1[k] (k=2, . . . , N) can be realized using the same hardware as described below. Specifically, either one of a parent node (distributed processing node 1[1]) or a child node (distributed processing node 1[k]) can be selected as a function of each of the distributed processing nodes by using an initial setting from the outside. In this way, in embodiments of the present invention, all of the distributed processing nodes can be realized at low cost.

As described in step S100 in FIG. 2, the sample input unit 16 of each of the distributed processing nodes 1[n] (n=1, . . . , N) inputs the sample data x[n, s] (s=1, . . . , S) for each mini batch from the data collecting node.

As described in step S101 in FIG. 2, the gradient calculation processing unit 17 of each of the distributed processing nodes 1[n] (n=1, . . . , N) calculates as follows when the sample data x[n, s] is input. Calculating as follows means to calculate the gradient G[m, n, s] of the loss function of the neural network 21 for each piece of sample data x[n, s] with respect to each of M weights w[m] (m=1, . . . , M) of the neural network 21.

As described in step S102 in FIG. 2, the in-node consolidation processing unit 18 of each of the distributed processing nodes 1[n] (n=1, . . . , N) generates and stores the distributed data D[m, n] (m=1, . . . , M), which is numerical values obtained by consolidating the gradient G[m, n, s] for each piece of sample data, for each weight w[m].

Next, the transmission unit 12 of each of the distributed processing nodes 1[n] (n=1, . . . , N) can be configured to be set, by using an initial setting from the outside, to operate as a transmission unit for the parent node (distributed processing node 1[1]) or operate as a transmission unit for the child node (distributed processing node 1[k], k=2, . . . , N).

The transmission unit 12 of the distributed processing node 1[1] configured as a parent node defines the M pieces of distributed data D[m, 1] (m=1, . . . , M) generated by the in-node consolidation processing unit 18 of the distributed processing node 1[1] as the intermediate consolidated data Rt[m, 1]. Then, the transmission unit 12 packetizes this intermediate consolidated data Rt[m, 1] in order of the number m of the weight w[m], and outputs the generated aggregation communication packet SP[p, 1] (p=1, . . . , P; P is an integer greater than or equal to 2) to the communication port 10 of the distributed processing node 1[1]. This aggregation communication packet SP[p, 1] is transmitted from the communication port 10 via the communication path 2[1] to the distributed processing nodes 1[2] of the following number (steps S103 and S104 in FIG. 3).

On the other hand, the reception unit 15 of each of the distributed processing nodes 1[k] (k=2, . . . , N) configured as a child node receives an aggregation communication packet SP[p, k−1] (p=1, . . . , P) from the distributed processing node 1[k−1] via the communication port 11 of the distributed processing node 1[k] and the communication path 2[k−1]. Then, the reception unit 15 acquires the intermediate consolidated data Rt[m, k−1] (m=1, . . . , M) from the received aggregation communication packet SP[p, k−] (steps S105, S106, S109, and S110 in FIG. 3).

The consolidated data generation unit 19 of each of the distributed processing nodes 1[k] (k=2, . . . , N) configured as a child node calculates, for each corresponding weight w[m] (for each number m), the sum of the intermediate consolidated data Rt[m, k−1] (m=1, . . . , M) acquired by the reception unit 15 of the distributed processing node 1[k] and the distributed data D[m, k]. Then, the consolidated data generation unit 19 generates the intermediate consolidated data Rt[m, k] in order of the number m (steps S107 and S111 in FIG. 3). Here, the distributed data D[m, k] is generated by the in-node consolidation processing unit 18 of the distributed processing node 1[k].

Then, the transmission unit 12 of each of the distributed processing nodes 1[k] (k=2, . . . , N) packetizes the M pieces of intermediate consolidated data Rt[m, k] (m=1, . . . , M) generated by the consolidated data generation unit 19 of the distributed processing node 1[k] in order of the number m of the weight w[m], and outputs the generated aggregation communication packet SP[p, k] (p=1, . . . , P) to the communication port 10 of the distributed processing node 1[k]. This aggregation communication packet SP[p, k] is transmitted from the communication port 10 via the communication path 2[k] to the distributed processing node 1[k+] (k⁺=k+1, provided that k⁺=1 if k=N) of the following number (steps S108 and S112 in FIG. 3).

Next, the transmission unit 14 of each of the distributed processing nodes 1[n] (n=1, . . . , N) can be configured, as with the transmission unit 12, to be set, by using the initial setting from the outside, to operate as a transmission unit for the parent node (distributed processing node 1[1]) or operate as a transmission unit for the child node (distributed processing node 1[k]; k=2, . . . , N).

The reception unit 15 of the distributed processing node 1[1] configured as a parent node receives an aggregation communication packet SP[p, N] from the distributed processing node 1[N] via the communication port 11 of the distributed processing node 1[1] and the communication path 2[N]. Then, the reception unit 15 acquires the intermediate consolidated data Rt[m, N] (m=1, . . . , M) from the received aggregation communication packet SP[p, N] (p=1, . . . , P) (steps S113 and S114 in FIG. 3).

The transmission unit 14 of the distributed processing node 1[1] configured as a parent node defines the intermediate consolidated data Rt[m, N] (m=1, . . . , M) acquired by the reception unit 15 of the distributed processing node 1[1] as the consolidated data R[m]. Then, the transmission unit 14 packetizes this consolidated data R[m] in order of the number m of the weight w[m], and outputs the generated dispatch communication packet DP[p, 1] (p=1, . . . , P) to the communication port 11 of the distributed processing node 1[1]. This dispatch communication packet DP[p, 1] is transmitted from the communication port 11 via the communication path 2[N] to the N^{th} distributed processing node 1[N] (step S115 in FIG. 3).

On the other hand, the reception unit 13 of each of the distributed processing nodes 1[k] (k=2, . . . , N) configured as a child node receives a dispatch communication packet DP[p, k+] (p=1, . . . , P) from the distributed processing node 1[k+] (k⁺=k+1, provided that k⁺=1 if k=N) via the communication port 10 of the distributed processing node 1[k] and the communication path 2[k]. Then, the reception unit 13 acquires the consolidated data R[m] (m=1, . . . , M) from the received dispatch communication packet DP[p, k⁺] (steps S116 and S117 in FIG. 3).

The transmission unit 14 of each of the distributed processing nodes 1[k] (k=2, . . . , N) configured as a child node packetizes the consolidated data R[m] (m=1, . . . , M) acquired by the reception unit 13 in order of the number m of the weight w[m], and outputs the generated dispatch communication packet DP[p, k] (p=1, . . . , P) to the communication port 11 of the distributed processing node 1[k]. This dispatch communication packet DP[p, k] is transmitted from the communication port 11 via the communication path 2[k−1] to the distributed processing node 1[k−] (step S118 in FIG. 3).

The reception unit 13 of the distributed processing node 1[1] configured as a parent node receives a dispatch communication packet DP[p, 2] (p=1, . . . , P) from the distributed processing node 1[2] via the communication port 10 of the distributed processing node 1[1] and the communication path 2[1]. Then, the reception unit 13 acquires the consolidated data R[m] (m=1, . . . , M) from the received dispatch communication packet DP[p, 2] (steps S119 and S120 in FIG. 3).

The transmission unit 12 of each of the distributed processing nodes 1[n] (n=1, . . . , N) acquires data in units of L (L is an integer greater than or equal to 1 and less than M) pieces, from the M pieces of intermediate consolidated data Rt[m, n] and in order of the number m of the weight w[m], and allocates the L pieces of data to each of the P (P is an integer greater than or equal to 2) aggregation communication packets. Then, the transmission unit 12 sequentially transmits the P aggregation communication packets to the distributed processing node 1[n⁺] (n⁺=n+1, provided that n⁺=1 if n=N) of the following number until all of the aggregation communication packets are transmitted. In other words, L pieces of intermediate consolidated data Rt[r, n] (r=L×(p−1)+l;l=1, . . . , L) are included in a p^{th} (p=1, . . . , P) aggregation communication packet SP[p, n] to be transmitted.

In a condition where M cannot be divided by L, (M−L×(P−1)) pieces of intermediate consolidated data Rt[r, n] (r=L×(P−1)+q; q=1, . . . , M−L×(P−1)) are included in the P^{th} aggregation communication packet SP[P, n].

Numerical values of {L−(M−L×(P−1))} dummies may be added after the (M−L×(P−1)) pieces of intermediate consolidated data Rt[r, n] for the P^{th} aggregation communication packet SP[P, n], and all of the aggregation communication packets may equally include L pieces of data.

The transmission unit 14 of each of the distributed processing nodes 1[n] (n=1, . . . , N) acquires data in units of L pieces, from the M pieces of consolidated data R[m] (m=1, . . . , M) and in order of the number m of the weight w[m], and allocates the L pieces of data to each of the P dispatch communication packets. Then, the transmission unit 14 sequentially transmits the P dispatch communication packets to a distributed processing node 1[n⁻] (n⁻=n−1, provided that n⁻=N if n=1) until all of the dispatch communication packets are transmitted. In other words, L pieces of consolidated data R[r] (r=L×(p−1)+l;l=1, . . . , L) are included in a p^{th} (p=1, . . . , P) dispatch communication packet DP[p, n] to be transmitted.

In a condition where M cannot be divided by L, (M−L×(P−1)) pieces of consolidated data R[r] (r=L×(P−1)+q; q=1, . . . , M−L×(P−1)) are included in the P^{th} dispatch communication packet DP[p, n].

Numerical values of {L−(M−L×(P−1))} dummies may be added after the (M−L×(P−1)) pieces of consolidated data R[r] for the P^{th} dispatch communication packet DP[P, n], and all of the dispatch communication packets may equally include L pieces of data.

The weight updating processing unit 20 of each of the distributed processing nodes 1[n] (n=1, . . . , N) performs a weight updating process of updating the weight w[m] of the neural network 21 in the distributed processing node 1[n], based on the consolidated data R[m] acquired by the reception unit 13 of the distributed processing node 1[n] (step S122 in FIG. 4).

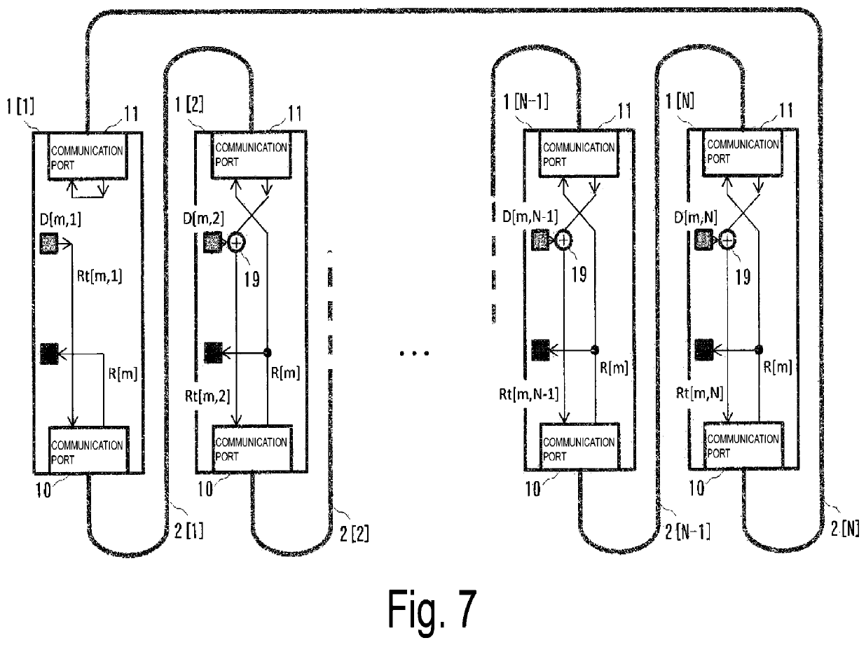

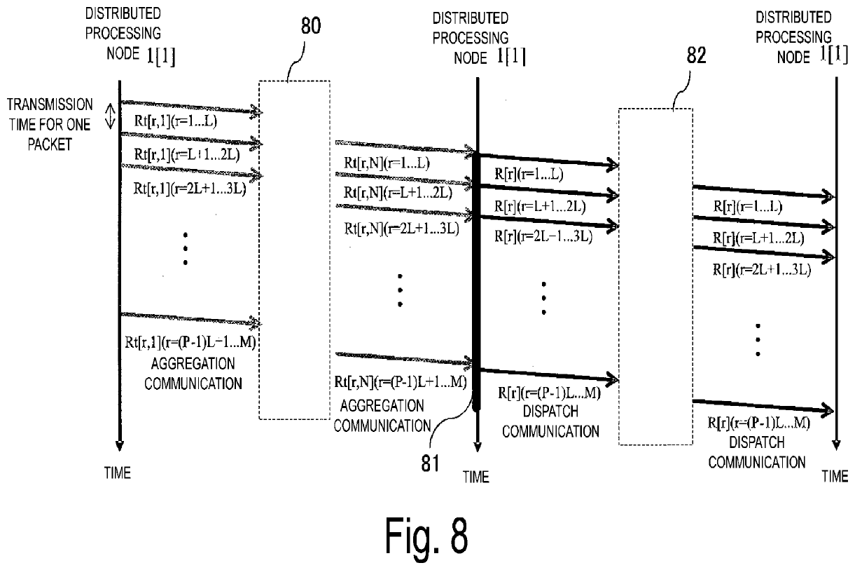

FIG. 7 illustrates an overview of a process of each of the distributed processing nodes 1[n] (n=1, . . . , N). FIGS. 8 to 10 illustrate a sequence of communication (aggregation communication and dispatch communication) of the intermediate consolidated data and the consolidated data between each of the distributed processing nodes 1[n] (n=1, . . . , N).

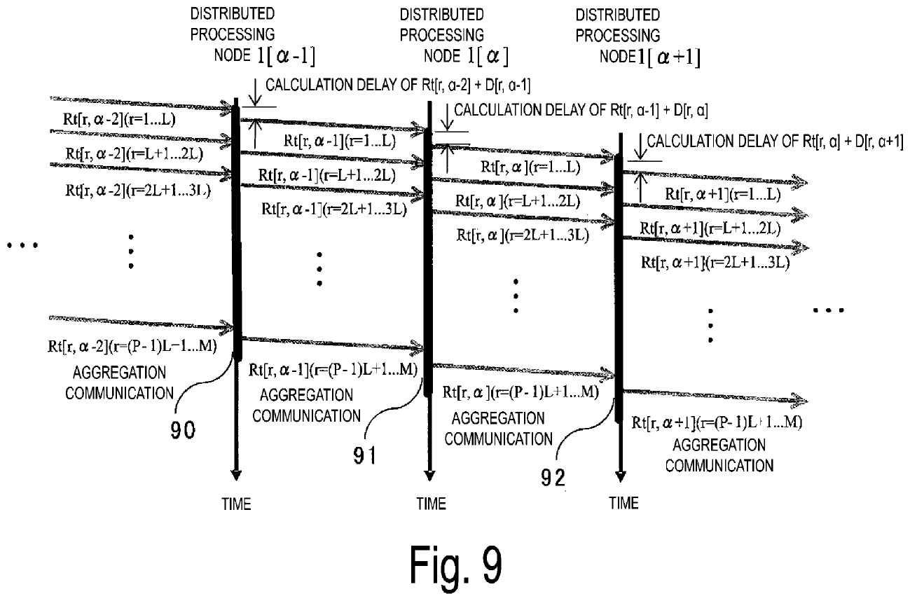

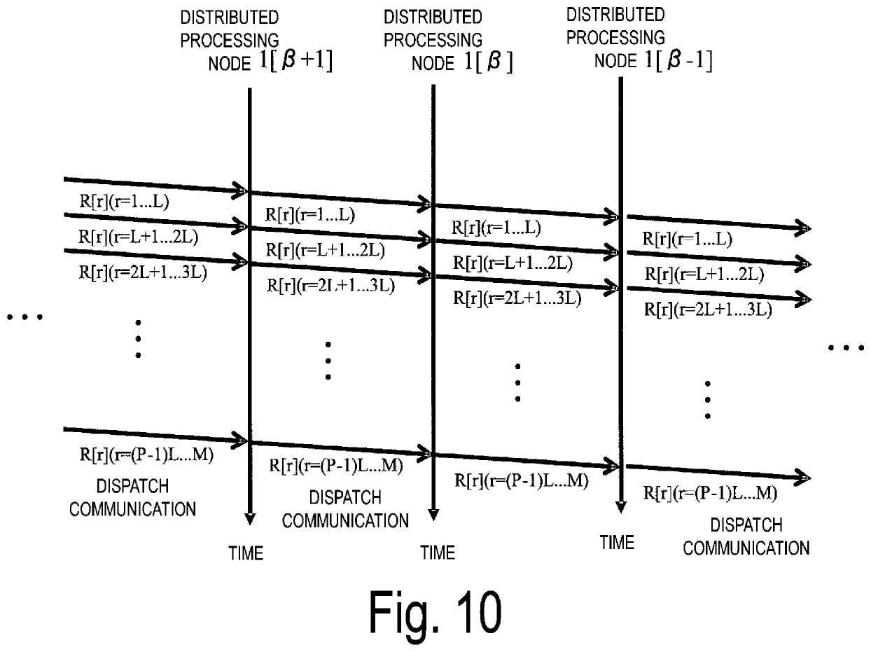

Note that FIG. 9 illustrates a process of a portion 80 in FIG. 8. A reference numeral 81 denotes an inter-node consolidation process at the distributed processing node 1[1]. Similarly, reference numerals 90, 91, and 92 in FIG. 9 denote the inter-node consolidation processes at distributed processing nodes 1[α−1], 1[α], and 1[α+1 ] (α=3, . . . , N−1). FIG. 10 illustrates a process of a portion 82 in FIG. 8, i.e., the dispatch communication processes of distributed processing nodes 1[β+1], 1[β], and 1[β−1] (β=N−1, . . . , 3).

As described above, all of the aggregation communication, the inter-node consolidation process, and the dispatch communication are performed in order of the number m of the weight w[m], and can be performed in a pipelined manner using the number m as a unit. Here, the aggregation communication is aggregation communication from the distributed processing node 1[n] (n=1, . . . , N) to the distributed processing node 1[n+] (n⁺=n+1, provided that n⁺=1 if n=N) (a process of transmitting the intermediate consolidated data Rt[m, n] to the distributed processing node 1[n⁺]) in which the distributed processing node 1[1] is a starting point and an end point. The inter-node consolidation process is an inter-node consolidation process performed by the distributed processing node 1[k] (k=2, . . . , N) (a process of calculating the intermediate consolidated data Rt[m, k] based on the received intermediate consolidated data Rt[m, k−1] and the distributed data D[m, k] generated at the distributed processing node 1[k]). The dispatch communication is dispatch communication from the distributed processing node 1[n] (n=1, . . . , N) to the distributed processing node 1[n⁻] (n⁻=n−1, provided that n⁻=N if n=1) (a process of distributing the consolidated data R[m] to each of the distributed processing nodes 1[n⁻]) in which the distributed processing node 1[1] is a starting point and an end point.

In the present embodiment, as illustrated in FIGS. 8 to 10, the aggregation communication process, the inter-node consolidation process, and the dispatch communication process can be performed concurrently and substantially simultaneously (in a pipelined manner using the number m as a unit), and a processing time can be drastically reduced as compared with the known art in which the next process cannot be started until communications and processes are terminated.

In addition, even in a case where the N distributed processing nodes 1[n] (n=1, . . . , N) are nodes including the same hardware, the above-described aggregation communication process, inter-node consolidation process, and dispatch communication process can be performed by selecting a node as a parent node (distributed processing node 1[1]) and then applying a setting depending on whether the node is the parent node or not to each of the nodes. As a result, the system can be extremely easily managed compared to a system requiring a separate setting for each of the nodes (the same setting may be applied to each of the nodes other than one parent node), and thus, the costs required for system management and administrative errors can be reduced.

Each of the distributed processing nodes 1[n] (n=1, . . . , N) described in the first and second embodiments can be realized by a computer including a central processing unit (CPU), a storage device, and an interface, and programs for controlling these hardware resources.

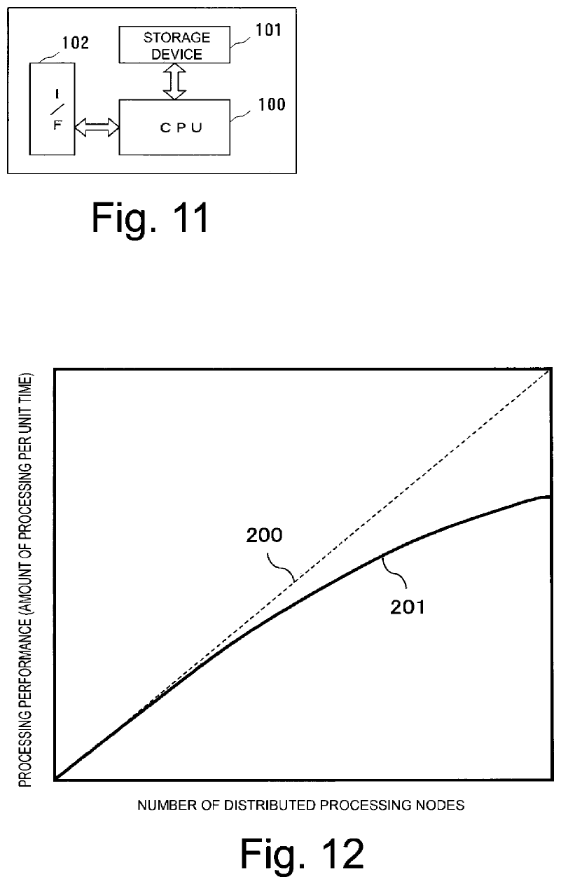

A configuration example of this computer is illustrated in FIG. 11. The computer includes a CPU 100, a storage device 101, and an interface device (hereinafter abbreviated as I/F) 102. A communication circuit including, for example, the communication ports 10 and 11 is connected to the I/F 102. The CPU 100 executes the processes described in the first and second embodiments in accordance with the program stored in the storage device 101, and realizes the distributed processing system and the distributed processing method of embodiments of the present disclosure.

### INDUSTRIAL APPLICABILITY

The embodiments of the present invention can be applied to techniques for performing machine learning of a neural network.

### REFERENCE SIGNS LIST

1 . . . Distributed processing node
2 . . . Communication path
10, 11 . . . Communication port
12, 14 . . . Transmission unit
13, 15 . . . Reception unit
16 . . . Sample input unit
17 . . . Gradient calculation processing unit
18 . . . In-node consolidation processing unit
19 . . . Consolidated data generation unit
20 . . . Weight updating processing unit
21 . . . Neural network

1.-6. (canceled)

7. A distributed processing system, comprising:
N distributed processing nodes arranged in a ring shape, wherein N is an integer greater than or equal to 2, each of the N distributed processing nodes being connected with adjacent nodes through a communication path, wherein an n^{th} distributed processing node, in which n=1, . . . , N, comprises a first communication port configured to simultaneously communicate in both directions with an n^{+th} distributed processing node, in which n⁺=n+1, provided that n⁺=1 if n=N, and a second communication port configured to simultaneously communicate in both directions with an n^{-th} distributed processing node, in which n⁻=n−1, provided that n⁻=N if n=1, wherein:
each of the N distributed processing nodes is configured to generate distributed data for M weights w[m] of a neural network that is a learning target, wherein M is an integer greater than or equal to 2 and m=1, . . . , M;
a predetermined first distributed processing node of the N distributed processing nodes is configured to define distributed data generated at the first distributed processing node as first consolidated data, packetize the first consolidated data in order of a number m of the weight w[m], and transmit the packet from the first communication port of the first distributed processing node to a second distributed processing node;
a k^{th} distributed processing node of the N distributed processing nodes, in which k=2, . . . , N, and the k^{th} distributed processing node is not the first distributed processing node, is configured to calculate, for each corresponding weight w[m], a sum of the first consolidated data received from a (k−1)^{th} distributed processing node via the second communication port of the k^{th} distributed processing node and the distributed data generated at the k^{th} distributed processing node to generate updated first consolidated data, packetize the updated first consolidated data in order of the number m, and transmit the packet from the first communication port of the k^{th} distributed processing node to a k^{+th} distributed processing node, wherein k⁺=k+1, provided that k⁺=1 if k=N;
the first distributed processing node is configured to define first consolidated data received from the N^{th} distributed processing node of the N distributed processing nodes via the second communication port of the first distributed processing node as second consolidated data, packetize the second consolidated data in order of the number m, and transmit the packet from the second communication port of the first distributed processing node to the N^{th} distributed processing node;
the k^{th} distributed processing node is configured to packetize, in order of the number m, the second consolidated data received from the k^{+th} distributed processing node via the first communication port of the k^{th} distributed processing node, and transmit the packet from the second communication port of the k^{th} distributed processing node to the (k−1)^{th} distributed processing node;
the first distributed processing node is configured to receive the second consolidated data from the second distributed processing node via the first communication port of the first distributed processing node; and
each of the distributed processing nodes is configured to update the weight w[m] of the neural network based on the received second consolidated data.

8. The distributed processing system according to claim 7, wherein each of the N distributed processing nodes comprises:
an in-node consolidation processor configured to generate the distributed data;
a first transmitter configured to, when a respective distributed processing node of the N distributed processing nodes is the first distributed processing node, packetize the first consolidated data in order of the number m and transmit the packet from the first communication port of the first distributed processing node to the second distributed processing node, and when the respective distributed processing node of the N distributed processing nodes is the k^{th} distributed processing node, packetize the updated first consolidated data in order of the number m and transmit the packet from the first communication port of the k^{th} distributed processing node to the k^{+th} distributed processing node;
a first receiver configured to acquire the first consolidated data from a packet received from the second communication port of the respective distributed processing node;
a second transmitter configured to, when the respective distributed processing node is the first distributed processing node, packetize the second consolidated data in order of the number m and transmit the packet from the second communication port of the first distributed processing node to the N^{th} distributed processing node, and when the respective distributed processing node is the k^{th} distributed processing node, packetize the received second consolidated data in order of the number m and transmit the packet from the second communication port of the k^{th} distributed processing node to the (k−1)^{th} distributed processing node;
a second receiver configured to acquire the second consolidated data from a packet received from the first communication port of the respective distributed processing node;
a consolidated data generator configured to, when the respective distributed processing node is the k^{th} distributed processing node, generate the updated first consolidated data; and
a weight updating processor configured to update the weight w[m] of the neural network based on the received second consolidated data.

9. The distributed processing system according to claim 8, wherein each of the N distributed processing nodes is configured to re-transmit the first consolidated data or the updated first consolidated data when the first distributed processing node fails to successfully receive the second consolidated data.

10. The distributed processing system according to claim 7, wherein each of the N distributed processing nodes is configured to re-transmit the first consolidated data or the updated first consolidated data when the first distributed processing node fails to successfully receive the second consolidated data.

11. A distributed processing method in a system comprising N distributed processing nodes arranged in a ring shape, wherein N is an integer greater than or equal to 2, each of the N distributed processing nodes being connected with adjacent nodes through a communication path, wherein an n^{th} distributed processing node, in which n=1, . . . , N, comprises a first communication port for simultaneously communicating in both directions with an n^{+th} distributed processing node, in which n⁺=n+1, provided that n⁺=1 if n=N, and a second communication port for simultaneously communicating in both directions with an nth distributed processing node, in which n⁻=n−1, provided that n⁻=N if n=1, the method comprising:
a first step of generating, at each of the N distributed processing nodes, distributed data for M weights w[m] of a neural network that is a learning target, wherein M is an integer greater than or equal to 2 and m=1, . . . , M;
a second step of defining, at a predetermined first distributed processing node of the N distributed processing nodes, distributed data generated at the first distributed processing node as first consolidated data, packetizing the first consolidated data in order of the number m of the weight w[m], and transmitting the packet from the first communication port of the first distributed processing node to a second distributed processing node;
a third step of calculating for each corresponding weight w[m], at a k^{th} distributed processing node of the N distributed processing nodes, in which k=2, . . . , N and the k^{th} distributed processing node is not the first distributed processing node, a sum of first consolidated data received from a (k−1)^{th} distributed processing node via the second communication port of the k^{th} distributed processing node and distributed data generated at the k^{th} distributed processing node to generate updated first consolidated data, packetizing the updated first consolidated data in order of the number m, and transmitting the packet from the first communication port of the k^{th} distributed processing node to a k^{+th} distributed processing node, wherein k⁺=k+1, provided that k⁺=1 if k=N;
a fourth step of defining, at the first distributed processing node, first consolidated data received from the N^{th} distributed processing node via the second communication port of the first distributed processing node as second consolidated data, packetizing the second consolidated data in order of the number m, and transmitting the packet from the second communication port of the first distributed processing node to the N^{th} distributed processing node;
a fifth step of packetizing, in order of the number m, at the k^{th} distributed processing node, second consolidated data received from the k^{+th} distributed processing node via the first communication port of the k^{th} distributed processing node, and transmitting the packet from the second communication port of the k^{th} distributed processing node to the (k−1)^{th} distributed processing node;
a sixth step of receiving, at the first distributed processing node, second consolidated data from the second distributed processing node via the first communication port of the first distributed processing node; and
a seventh step of updating, at each of the N distributed processing nodes, the weight w[m] of the neural network based on the received second consolidated data.

12. The distributed processing method according to claim 11, wherein the third step comprises:
at the k^{th} distributed processing node, acquiring the first consolidated data from a packet received from the second communication port of the k^{th} distributed processing node;
generating the updated first consolidated data; and
packetizing the updated first consolidated data in order of the number m and transmitting the packet from the first communication port of the k^{th} distributed processing node to the k^{+th} distributed processing node.

13. The distributed processing method according to claim 12, wherein the fourth step comprises:
at the first distributed processing node, acquiring the first consolidated data from a packet received from the second communication port of the first distributed processing node;
defining the acquired first consolidated data as the second consolidated data;
packetizing the second consolidated data in order of the number m; and
transmitting the packet from the second communication port of the first distributed processing node to the N^{th} distributed processing node.

14. The distributed processing method according to claim 13, wherein the fifth step comprises:
at the k^{th} distributed processing node, acquiring the second consolidated data from a packet received from the first communication port of the k^{th} distributed processing node; and
packetizing the received second consolidated data in order of the number m and transmitting the packet from the second communication port of the k^{th} distributed processing node to the (k−1)^{th} distributed processing node.

15. The distributed processing method according to claim 14, wherein the sixth step comprises, at the first distributed processing node, acquiring the second consolidated data from a packet received from the first communication port of the first distributed processing node.

16. The distributed processing method according to claim 15, further comprising, at each of the distributed processing nodes, performing the second, third, fourth and fifth steps again when the first distributed processing node fails to successfully receive the second consolidated data in the sixth step.

17. The distributed processing method according to claim 11, further comprising, at each of the distributed processing nodes, performing the second, third, fourth and fifth steps again when the first distributed processing node fails to successfully receive the second consolidated data in the sixth step.
